(19) United States
(12) Patent Application Publication
(10) Pub. No.: US 2008/0106638 A1
(43) Pub. Date: May 8, 2008

(54) Internet media experience data compression scheme

(75) Inventors: Kenneth S. Bailey, Newport Beach, CA (US); Christopher Carmichael, Laguna Beach, CA (US)

Correspondence Address: Law Office of Scott C Harris, PO Box 1389, Rancho Santa Fe, CA, 92067, US

(73) Assignee: UBIQUITY HOLDINGS, San Juan Capistrano, CA (US)

(21) Appl. No.: 11/866,937

(22) Filed: Oct. 3, 2007

Related U.S. Application Data
(60) Provisional application No. 60/850,468, filed on Oct. 10, 2006.

(51) Int. Cl. H04N 7/015

(52) U.S. Cl. 348/384.1; 348/E07.004

(57) ABSTRACT

A basic high-definition image is divided into tiles. Each of the tiles is analyzed to determine how it can be compressed. The tiles are both compressed and reduced in size according to the desired target, where the target is how many pixels are available on the screen of a device that is going to be used to display the video.

This application claims priority from application No. 60/850,468, filed Oct. 10, 2006, the disclosure of which is herewith incorporated by reference.

### BACKGROUND

Video and images can be formed and displayed in different resolutions. Often, the resolution that is used for a video or image depends on the hardware that is going to be used to show the video or image.

Different video display hardware is known. The ability to carry out a video display depends on a number of factors, including the processing capability of a hardware that is going to display the image; the amount of memory on the image, as well as other features.

### SUMMARY

The present application describes techniques of improving compression ratios to compress data into smaller bandwidths, and application of which has the purpose of sending high definition images and video over a cellular network.

According to an embodiment, a compression technique is used which may be located on server computers that compress streaming video data. A technique may be used for compression which uses much more complexity to encode the data then it uses to uncompress the data. Decompression of streaming data may be used, for example, on a cellular phone.

### BRIEF DESCRIPTION OF THE DRAWINGS

These and other aspects will now be described in detail with reference to the accompanying drawings wherein:

FIGS. 1A-1C illustrate encoding an image using tiles; and

FIG. 2 illustrates encoding an image for different sized screens.

### DETAILED DESCRIPTION

According to the present system, static pixels in a scene are separated from the moving pixels in each scene. Static data is compressed using the first compression technique. The motion data is compressed separately using a different compression technique. Simple scenes may be compressed using haar wavelets, and more complex scenes may be compressed using daubechies wavelets with four and six filter coefficients. Audio portions of the transmission may be compressed using conventional audio compression techniques.

An intent of this system is to allow data from a high definition image or video to be compressed down to a lower definition.

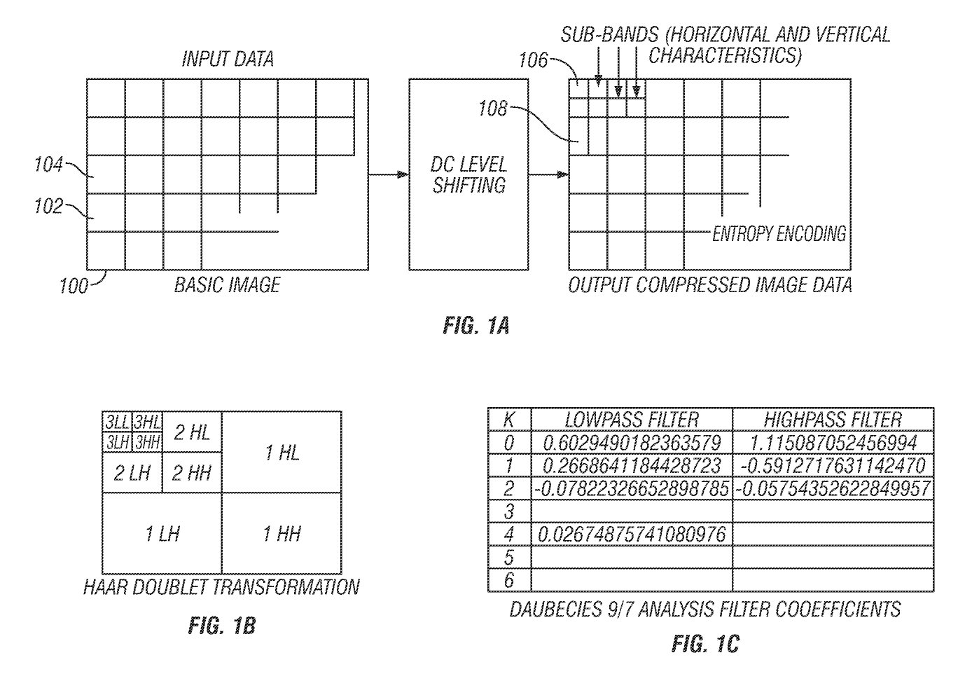

FIG. 1 illustrates an embodiment where the input data 100 is divided into tiles such as 102, 104. Each of the individual tiles may be individually encoded. For example, a tile 106 may be encoded into for subbands shown within the tile. Other tiles such as 108 may be encoded into fewer subbands. For example, the tile 106 is encoded in a way that allows encoding both horizontal and vertical characterizations. The tile 108 divides in a way that only carries out horizontal and vertical characterizations. This choice may be based on the characterization of the specific content within each specific tile.

FIG. 1B shows how a doublet transformation may be formed with a number of different coefficients, such as the coefficients shown in FIG. 1 C.

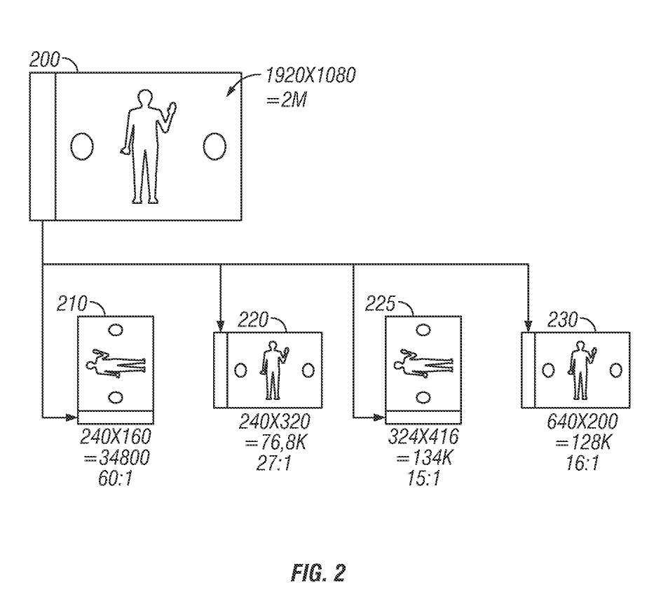

According to one aspect, reduced versions of the high definition image or frame 200 may be obtained for different platforms. For example, the 1920×1080 image or video frame may be a divided down to a much smaller image. As illustrated in FIG. 2, the original image/frame 200 may be divided in different ways depending on hardware characteristics of the display screen that will display the image. In essence, the high-definition original image is fractionated according to the desired image size. The image reduction may use fractal techniques to attempt to select one of the pixels within an area of the original image 200 from among many pixels in a way that retains the characteristics of that original image.

For example a PDA screen of 240×160 has 1/60th the number of pixels of the original image. In order to convert the original hi def image/frame, into an image/frame of 240×160, one out of every 60 pixels in the original image must be selected for the new image. This can use, for example, a fractal function to select a random pixel. Alternatively, it may simply select a random pixel, or a pixel that forms the least motion vector or the most motion vector. The fractal image coding works best for areas of the image that are reasonably consistent, that is have less change therein. Accordingly, portions of the image which are detected as being reasonably static may be compressed using a function that selects a random pixel within this reasonably-consistent area.

In a similar way, compressions for different displays, here for a 240×320( 1/27) display 220, a 324×416( 1/15) display 225, and a 640×200( 1/16) display 230 may all be carried out. Each of these may be thought of as a different subset of the 1920 by 1080 pixel frame. Moreover, since each of these screens has a different arrangement, the image may be rotated in a way that allows the arrangement to be best displayed.

Another embodiment may simply set the compression level to the correct fraction to meet the necessary pixel reduction. For example, a lossy compression scheme can be used for the 240 by 160 screen that forces a 60:1 compression ratio.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the word “frame” and “image” may be considered interchangeable. Also, a high definition image can be any image greater than 720p. Other compression schemes can also be used besides those specifically described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. a method, comprising:
obtaining a high-definition frame;
dividing said high-definition image into a plurality of areas, each area representing only a part of the entire high definition frame;
determining, for each area, an amount of motion within the area as compared with a similar area for a different time;
first compressing areas which have motion less than a specified amount using a first compression technique, and compressing areas which have motion greater than said specified amount using a second compression technique different than the first compression technique to form a compressed video frame;
second compressing other video frames using the same technique as said first compressing; and
sending a compressed video over a cellular link to a specified wireless communicator.

2. A method as in claim 1, further comprising determining a screen size of a cellular phone that will display the frame, and wherein said first compressing comprises compressing the high-definition frame to a fraction of its original size, wherein the fraction is based on a difference between a total number of pixels in the high-definition frame and a total number of pixels in the screen size of the cellular phone.

3. A method as in claim 1, wherein said first compression technique is a doublet transformation, and said second compression technique is an analysis filter transformation.

4. A method as in claim 1, further comprising analyzing each area of the frame to determine if the each area can be compressed in both horizontal and vertical directions.

5. A method as in claim 1, further comprising rotating the frame to display the frame on the screen of a cellular telephone at an orthogonal orientation relative to an original frame.

6. A method as in claim 2, wherein said first compressing uses a fractal reduction technique.

7. A method, comprising:
obtaining a high definition frame of a high definition video, wherein said high definition frame has a size of at least 720i;
determining plural different smaller sizes of plural different screens, each of said plural different screens being for a different cell phone, said screens including at least a first screen having a first size, and a second screen having a second size;
determining a fraction between a size of said high definition frame and a size of said first screen, and a second fraction between said size of said high definition frame and a size of said second frame; and
carrying out a first compression of said high definition frame to form said high definition frame into the size of said first screen, and carrying out a second fraction between said high definition frame and said second screen to form said high definition frame into the size of said second screen.

8. A method as in claim 7, further comprising rotating the high definition frame to an orthogonal orientation as part of said forming said high definition frame into the size of said second screen.

9. A method as in claim 7, further comprising third and fourth compressions, and wherein said compressions reduce said high definition frame to sizes of 240×160, 240×320, 324×416, and 640×200.

10. A method, comprising:
obtaining a high definition frame of high definition video, having a size of at least 720i;
determining a size of a screen on a cellular phone that is to display said high definition video;
reducing the size of said high definition frame to fit the screen, and also rotating the high definition frame to an orthogonal configuration to fit the screen.

11. A method as in claim 10, wherein said reducing comprises determining plural different smaller sizes of plural different screens, each of said plural different screens being for a different cell phone, said screens including at least a first screen having a first size, and a second screen having a second size;
determining a fraction between a size of said high definition frame and a size of said first screen, and a second fraction between said size of said high definition frame and a size of said second frame; and
carrying out a first compression of said high definition frame to form said high definition frame into the size of said first screen, and carrying out a second fraction between said high definition frame and said second screen to form said high definition frame into the size of said second screen.
